(19) United States
(12) Patent Application Publication
(10) Pub. No.: US 2014/0149854 A1
(43) Pub. Date: May 29, 2014

(54) SERVER AND METHOD FOR GENERATING OBJECT DOCUMENT

(71) Applicants: HON HAI PRECISION INDUSTRY CO., LTD., NEW TAIPEI (TW); HONG FU JIN PRECISION INDUSTRY (ZHENZHEN) CO., LTD., SHENZHEN (CN)

(72) Inventors: CHUNG-I LEE, New Taipei (TW); DE-YI XIE, Shenzhen (CN); HAI-YUN CHEN, Shenzhen (CN); AN-SHENG LUO, Shenzhen (CN)

(73) Assignees: HON HAI PRECISION INDUSTRY CO., LTD., NEW TAIPEI (TW); HONG FU JIN PRECISION INDUSTRY (ZHENZHEN) CO., LTD., SHENZHEN (CN)

(21) Appl. No.: 14/066,969

(22) Filed: Oct. 30, 2013

(30) Foreign Application Priority Data
Nov. 26, 2012 (CN) 2012104856619

(51) Int. Cl. G06F 17/24

(52) U.S. Cl. CPC G06F 17/248
USPC 715/243

(57) ABSTRACT

A server stores a plurality of initial files and parameters of the initial files. When a user inputs contents of the initial files to the server, the server obtains a template for each initial file. The server searches for contents of all columns in each template from the parameters and the input contents. The searched contents are put in the columns of each template. The templates with the put contents are generated to object files corresponding to the initial files.

### BACKGROUND

1. Technical Field

Embodiments of the present disclosure relate to document management technology, and more particularly to a server and a method for generating object document.

2. Description of Related Art

Different servers may have different file forms. If files of a server are required to transfer to another server, the forms of the files need be changed to accord with a standard file form of another server. For example, when an applicant wants to file a patent application to the USPTO, the applicant can submit files of the patent application to the USPTO manually or adopt electronic delivery. However, the files of the patent application may not be submitted successfully because of the standard file form required by the USPTO.

### BRIEF DESCRIPTION OF THE DRAWINGS

FIG. 1 is a block diagram of one embodiment of a server including a generation system.

FIG. 2 is a block diagram of one embodiment of function modules of the generation system in FIG. 1.

FIG. 3 is a flowchart of one embodiment of a method for generating object documents.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

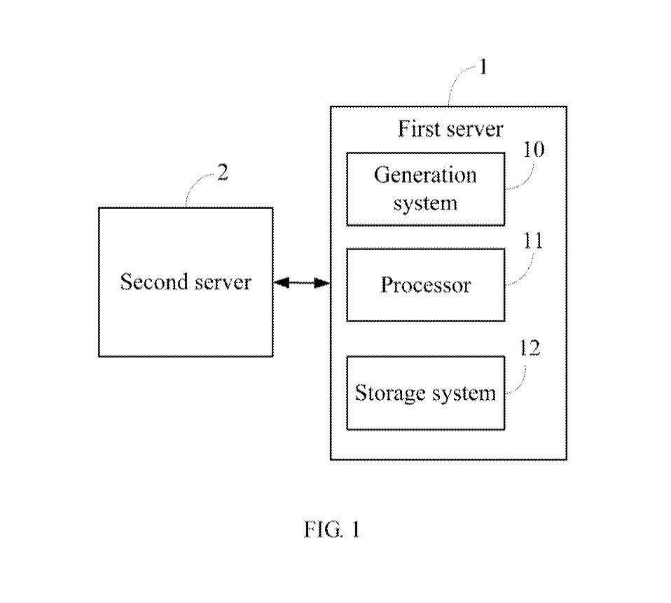

FIG. 1 is a block diagram of one embodiment of a first server 1. The first server 1 includes a generation system 10, a processor 11, and a storage system 12. The computing device 1 connects to a second server 2. The second server 2 provides a standard form of object documents to be generated to the first server 1. In one embodiment, the server 2 may be a server of a patent office, for example. The storage system 12 stores a plurality of initial files, and parameters and types of the initial files. Each initial file may include a specification and drawings of a patent or a patent application. A file form of each initial file may be a WORD file, a PDF file or a TIF file. Each initial file has an identifier. The type of each initial file may be an application, a response to an office action, for example. The parameters of each initial file may include an application number, an applicant, a name of the application, etc.

The storage system 12 stores a plurality of templates for each type of initial files. The templates accord with the standard form of object documents in the second server 2. Each template can be edited and includes a plurality of columns. The columns may include an applicant column, an application number column, for example. The generation system 10 stores content of the initial files to a corresponding template in the second server 2, and generates object files corresponding to the initial files. Then the object files are transferred to the second server 2.

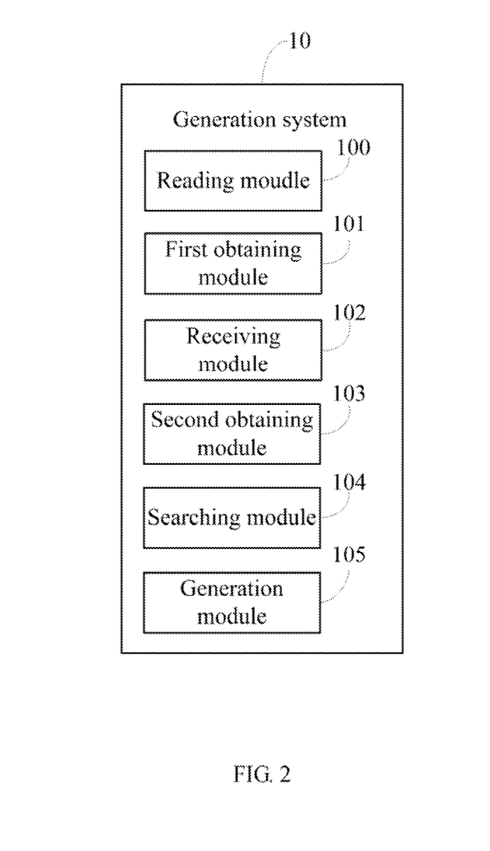

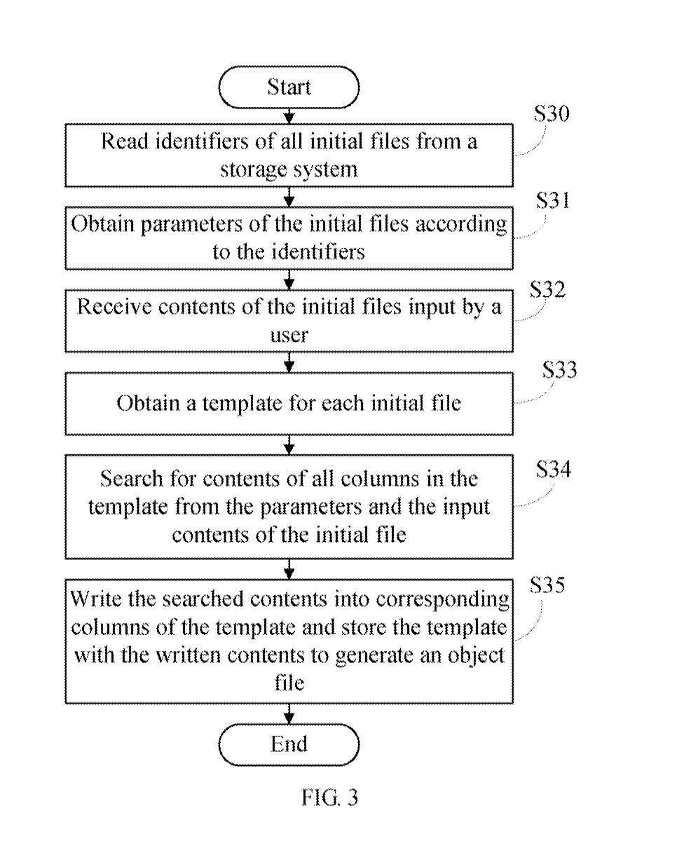

As shown in FIG. 2, the generation system 10 includes a plurality of function modules, such as a reading module 100, a first obtaining module 101, a receiving module 102, a second obtaining module 103, a searching module 104, and a generation module 105. The modules 100-105 include computerized code in the form of one or more programs that are stored in the storage system 12. The computerized code includes instructions that are executed by the processor 11, to provide functions of the generation system 10. Detailed functions of the modules 100-105 are given in reference to FIG. 3.

FIG. 3 is a flowchart of one embodiment of a method for adjusting the computing device. Depending on the embodiment, additional steps may be added, others removed, and the ordering of the steps may be changed.

In step S30, the reading module 100 reads the identifiers of all the initial files and all initial files corresponding to the identifiers in the storage system 12. In one embodiment, the identifier may be a country code. The reading module 100 reads the initial files according to the country code. For example, the reading module 100 reads all initial files of US application patent according to the country code “US.”

In step S31, the first obtaining module 101 obtains parameters of the initial files from the storage system 12 according to the identifiers of the initial files.

In step S32, the receiving module 102 receives contents of the initial files inputted by a user via the first server 1. The contents are used to generate object files. For example, the contents may be text of a response file regarding an office action. The receiving module 102 can provide an interface for the user to input the contents. In another embodiment, the receiving module 102 can obtain the contents from a file provided by the user.

In step S33, the second obtaining module 103 obtains a template for each initial file. If the initial file is a US application file, the second obtaining module 103 obtains a template for the US application file.

In step S34, the searching module 104 searches for contents of all columns in the template from the parameters and the input contents of the initial file. For example, the searching module 104 searches the parameters of an initial file for an application number column in a template corresponding to the initial file.

In step S35, the generation module 105 writes the searched contents into corresponding columns of the template. The generation module 105 also stores the template with the written contents to generate an object file corresponding to the written contents.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A server, comprising:
a processor; and
a non-transitory computer-readable medium that stores one or more programs, which comprise instructions which when executed by the processor of the electronic device, performs operations of:
(a) obtaining parameters of initial files in the server;
(b) receiving contents of the initial files inputted by a user via the server;
(c) obtaining a template for each initial file according to a type of the initial file;
(d) searching for contents of all columns in the template from the parameters and the input contents of the initial file; and
(e) writing the searched contents into corresponding columns of the template to generate an object file corresponding to the initial file.

2. The server as claimed in claim 1, wherein before operation (a) the operations further comprise:
reading identifiers of all the initial files and all initial files corresponding to the identifiers in the storage system.

3. The server as claimed in claim 2, wherein the parameters of the initial files are obtained according to the identifiers of the initial files.

4. The server as claimed in claim 1, wherein the templates accord with standard forms of the object documents.

5. A method being executed by a processor of a server, comprising steps:
(a) obtaining parameters of initial files in the server;
(b) receiving contents of the initial files inputted by a user via the server;
(c) obtaining a template for each initial file according to a type of the initial file;
(d) searching for contents of all columns in the template from the parameters and the input contents of the initial file; and
(e) writing the searched contents into corresponding columns of the template to generate an object file corresponding to the initial file.

6. The method as claimed in claim 5, wherein before step (a) the method further comprises:
reading identifiers of all the initial files and all initial files corresponding to the identifiers in the storage system.

7. The method as claimed in claim 6, wherein the parameters of the initial files are obtained according to the identifiers of the initial files.

8. The method as claimed in claim 5, wherein the templates accords with standard forms of the object documents.

9. A non-transitory computer-readable medium having stored thereon instructions that, when executed by a processor of a server, cause the processor to perform operations of:
(a) obtaining parameters of initial files in the server;
(b) receiving contents of the initial files inputted by a user via the server;
(c) obtaining a template for each initial file according to a type of the initial file;
(d) searching for contents of all columns in the template from the parameters and the input contents of the initial file; and
(e) writing the searched contents into corresponding columns of the template to generate an object file corresponding to the initial file.

10. The non-transitory computer-readable medium as claimed in claim 9, wherein before operation (a) the operations further comprise:
reading identifiers of all the initial files and all initial files corresponding to the identifiers in the storage system.

11. The non-transitory computer-readable medium as claimed in claim 10, wherein the parameters of the initial files are obtained according to the identifiers of the initial files.

12. The non-transitory computer-readable medium as claimed in claim 9, wherein the templates accords with standard forms of the object documents.
